(19) United States
(12) Patent Application Publication
(10) Pub. No.: US 2010/0263959 A1
(43) Pub. Date: Oct. 21, 2010

(54) EXTERNAL-ROTOR ELECTRIC MOTOR WITH OR WITHOUT A PLANETARY GEAR MECHANISM, MOTOR VEHICLE WITH AN EXTERNAL-ROTOR ELECTRIC MOTOR AND A METHOD FOR OPERATING SUCH A VEHICLE

(76) Inventors: Rudolf Hoebel, Egling (DE); Robert Haas, Marquartstein (DE); Michael Hörmann, Hohenrain (DE)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/669,721

(22) PCT Filed: Jul. 18, 2008
(86) PCT No.: PCT/IB2008/052901

§ 371 Date: Jun. 23, 2010

(30) Foreign Application Priority Data
Jul. 18, 2007 (DE) 10 2007 033 838.6
Sep. 14, 2007 (DE) 10 2007 044 078.4

(51) Int. Cl. B62D 5/00

(52) U.S. Cl. 180/443

(57) ABSTRACT

The electric motor (25) according to the invention for a motor vehicle has a stator (1) with predefined areas (4) for connection to a vehicle frame, wherein connection of the stator (1) can be done to the vehicle frame by welding or screwing, for example. In addition, the electric motor (25) according to the invention has a rotor (13), wherein the rotor (13) can be arranged on a drive shaft (17) that is mounted rotatably in the stator (1). The electric motor (25) is realized as an external rotor motor and has a planetary gear mechanism (26).

The invention relates to an external rotor electric motor with an optional planetary gear mechanism for a motor vehicle, particularly for a bicycle with an electric propulsion. It further relates to a motor vehicle with such an external rotor electric motor and a method for operating such a vehicle.

Bicycles with an electric motor serving as a auxiliary drive usually have a first driving means such as a chain that transmits the torque produced by the rider via pedals from a front sprocket to a rear sprocket and thus to the wheels, and a second driving means that transmits the torque produced by the electric motor to the wheels of the vehicle.

U.S. Pat. No. 5,570,752 A discloses a bicycle having an electric motor with a relatively complicated and elaborate transmission design for transmitting the torque of the electric motor.

From the DE 195 22 419 A1 a bicycle having an electric motor which is realized as a brushless disc motor whose front chain sprocket is realized as a permanent magnet and forms the rotor of an electric motor is known. A stator disc is clamped with coils (windings) in the area of the pedal bearing that acts on the permanent magnet.

The drawback in this arrangement is that support pins must be provided for supporting the torque against the vehicle frame for robust operation of the vehicle. Moreover, due to the design of the permanent magnet, the sprocket is expensive and heavy and electrical efficiency is low.

Other citations include DE 196 29 788 A1, U 3 884 317 A, GB 2 414 452 A, DE 196 21 440 A1, EP 0 258 041 A2, EP 0 590 674 A1, DE 195 22 419 A1, DE 44 21 428 C1, U.S. Pat. No. 5,570,752 A, U.S. Pat. No. 6,629,574 B2 and DE 100 26 528 A1. All these documents are not relevant to the subject matter of the patent claims.

The object of the invention is to provide a light and compact vehicle with electric motor drive which has at once a simple and robust construction and satisfactory efficiency.

According to the invention, this object is achieved by the object of the independent patent claims. Advantageous further developments of the invention are the object of the dependent patent claims.

An electric motor for a motor vehicle according to the invention has a stator with at least one or with a plurality of predefined areas for connecting to a vehicle frame, whereby the connection of the stator with the vehicle frame can be done exemplarily by welding or by screw fastening and the areas provided for the connection are correspondingly suitably designed. In addition, the electric motor according to the invention has a rotor as well as predefined areas for receiving a driving means. The electric motor is realized as an external rotor and has a planetary gear mechanism.

Therein, the rotor can be realized also as part of the planetary gear mechanism or in one piece with a part of the planetary gear mechanism.

The external-rotor motor exhibits a radial design comprised of a central shaft that is supported in a bearing support of the stator. The electromagnets of the stator connect radially to the bearing support, that have ferromagnetic yokes with coils, wherein the coils are arranged in such a fashion that their longitudinal axes are oriented radially and thus produce a likewise radially oriented magnetic field. A number of permanent magnets of the rotor that are arranged on the inside of the ring embracing the stator and oppose the yoke ends connect radially to the yoke ends.

In one embodiment, the rotor is arranged on a drive shaft that is supported rotatably in the stator. This embodiment is particularly suitable if the electric motor is provided for installation in a bicycle. In this case, cranks with pedals can engage on the drive shaft and the electric motor according to the invention has the advantage that it can be securely and compactly integrated in the area of the pedal bearing in the frame, and that it can be realized as an integral component of the vehicle frame, and so is robust and particularly stable.

If the electric motor is intended for installation in a motor cycle or motor bike that does not have driver pedals arranged on a crank, there is on the one hand the possibility of providing a shortened drive shaft, if necessary, on which, for example, a pinion for receiving a chain, a cardan pinion for receiving a cardan shaft or a belt pulley for receiving a toothed belt is mounted. On the other hand there is also the possibility of not providing a drive shaft but providing a predefined area for receiving a driving means, that is connecting e.g. a pinion or a belt pulley, directly to elements of the planetary gear mechanism. In this embodiment, too, the electric motor according to the invention can be realized as an integral component of the frame, and thus particularly stable.

For example, the stator can be fastened with screws or welded to frame tubes of the vehicle, in particular those of a bicycle or motorcycle. A separate torque support is thus unnecessary.

In addition, the electric motor according to the invention has the advantage that, due to the favorable geometry of the electric motor, which has a plurality of small permanent magnets instead of a solid disc, it can be designed relatively compact and space saving. External-rotor motors have a relatively large moment of inertia that which in the present application translates very advantageously to the running smoothness of the vehicle.

In virtue of the planetary gear mechanism, a gear reduction or gear increase can be achieved. A switchable planetary gear mechanism can also be provided. In particular, it can be achieved that both the torque produced by a rider by pedaling and also the torque provided by the electrical motor can be transferred simultaneously to the wheels of the vehicle, although the rider's pedaling cadence is different from the frequency of the electric motor. It is thereby possible, despite a normal pedaling cadence of the rider, to operate the electric motor in a frequency range that exhibits a particularly high efficiency or is otherwise favorable. Thereby, the motor is generally operated with a significantly higher frequency than the pedaling cadence of the rider.

Various embodiments of the planetary gear mechanism are conceivable. In one embodiment, a planet carrier of the planetary gear mechanism is securely connected to the stator of the electric motor. Therein it is either possible that the annulus gear of the planetary gear mechanism is securely connected to the rotor or that the sun wheel of the planetary gear mechanism is securely connected to the rotor.

In another embodiment, the sun wheel of the planetary gear mechanism is connected securely to the stator. In this embodiment either the annulus gear or the planet carrier of the planetary gear mechanism is securely connected to the rotor. In this embodiment the drive shaft, provided that it is present, is supported advantageously in a hollow shaft.

In another embodiment, the annulus gear of the planetary gear mechanism is securely connected to the stator. Here either the sun wheel or the planet carrier of the planetary gear mechanism is connected securely to the rotor.

In a preferred embodiment, the electric motor is realized as an electronically commutated d.c. external-rotor motor. Energy accumulators such as storage batteries for operating the electric motor can be provided in the area of the rear wheel or behind a rider seat. In this embodiment, the electric motor is realized brushless and the rotor has a number of permanent magnets. Brushless electric motors have the advantage that they have a longer lifespan and higher efficiency than those with a brush system. By preventing so called brush sparking, a reduction of high-frequency electromagnetic interference is achieved.

The areas for receiving a driving means are, for example, realized as sprocket wheel or as a toothed belt disk. Preferably, the areas for receiving the driving means are fixedly screw fastened to the drive shaft or to areas of the planetary gear.

In one embodiment, cranks with pedals can be fastened to the ends of the drive shaft. The electric motor can thus be integrated in the pedal bearing of the bicycle, or, respectively, parts of the electric motor form the pedal bearing, and the electric motor and the pedals that are operated by the power of the rider engage on the same shaft. Thereby, the construction of the electric motor according to the invention is particularly simple and compact.

In an advantageous embodiment, the drive shaft has a free-wheeling device in a transition area to the rotor. This has the advantage that coasting of the vehicle is possible even without a simultaneous rotation of the drive shaft, so that the rider does not have to constantly pedal. Free-wheeling is thus expediently provided if the electric motor is used for a bicycle.

In one embodiment, the rotor has a diameter D with 250 mm ≦D≦350 mm. The height h of the rotor is 30 mm ≦h≦60 mm, for example. Accordingly, the electric motor is compact enough to be arranged in the area of the pedal bearing between the pedal cranks of the vehicle and thus also approximately in the center of gravity of the vehicle.

A vehicle according to the invention, for example a bicycle with an electric motor or a motorcycle, comprises the electric motor according to the invention, whereby the stator of the electric motor is connected to frame tubes and a drive shaft connected by a driving means to a wheel of the motor vehicle. The stator can be welded or screw-fastened to frame tubes of the vehicle. In each case it is stably connected to the vehicle frame and thus requires no torque support against the bicycle frame.

Advantageously, the sprocket wheel is connected fixedly to the drive shaft and either to the planet carrier or the sun wheel or the annulus gear of the planetary gear.

In one embodiment cranks with pedals are fastened to the ends of the drive shaft. Thus the electric motor can be affixed in the area of the pedal bearing of a bicycle and replace it, whereby the motor and the rider engage at the same drive shaft.

A method according to the invention for operating a motor vehicle using an electric motor with a planetary gear mechanism realized as an external rotor comprises the following steps: A stator of the electric motor is provided with coils for generating magnetic fields in radial direction, whereby the coils have connections for a supply voltage. In addition, a rotor of the electric motor is provided with permanent magnets, whereby the permanent magnets are so arranged that they are situated radially opposite the coils with reference to an axis of rotation of the rotor. The supply voltage is switched in such a way that the magnetic field generated by means of the current flowing through the coils exercises a force of attraction on the permanent magnets of the rotor and thus a torque on the rotor.

An electronic commutator for switching the supply voltage is used advantageously so that the electric motor can be realized brushless. The supply voltage is triggered by a Hall sensor or by evaluating induced currents in the coils, for example. In this fashion a very exact triggering of the supply voltage is ensured so that high motor revolution speeds of the electric motor are also possible.

One of the several ideas forming the basis of the invention includes that the support areas of the stator, that can be realized as a plate or as a grid plate, for example, represent an integral or self-supporting component of the vehicle frame. In this fashion, the electric motor according to the invention can be integrated particularly well and simply in a vehicle. In contrast to the prior art, where complicated additional components must be provided, the electric motor according to the invention fits into a frame design, whereby advantageously, in a particular embodiment, an output shaft of the electric motor can be realized as a pedal bearing axis, for example for a crank-driven vehicle.

If a rear wheel suspension for the vehicle is provided using a rocker arm, as is common in motorcycles, for example, the electric motor according to the invention is arranged advantageously such that its axis of rotation; in other words, the axis of rotation of the rotor or the drive shaft coincides with the axis of rotation of the rocker arm or at least lies closely in its area. Therein, the arms of the rocker arm may engage also on both sides of the vehicle at the drive shaft, if appropriate.

With the present embodiment, electric motors with substantially higher efficiency than in the prior art can be provided as well.

In one embodiment, permanent magnets can be arranged radially on the circumference of the rotor that can be acted upon with electromagnetic power by the likewise radially arranged coils of the stator. Permanent magnets that are arranged radially on the circumference and corresponding yokes of electromagnets are particularly well suited, because with these the gap space varies only to a minimum degree, which provides a high efficiency. For the known electric motors in the prior art, the gap width between the stator and the rotor is subject to substantially greater fluctuations.

The exemplary embodiments of the invention are described essentially with permanent magnets on the rotor and with electromagnetic coils on the stator. It is also possible to provide permanent magnets on the stator and to operate these using electromagnets on the rotor, which means a higher circuit complexity. In addition, electromagnets can also be provided both on the stator and on the rotor without departing from the basic concept of the invention.

Embodiments of the invention are more closely described in the following using the enclosed figures.

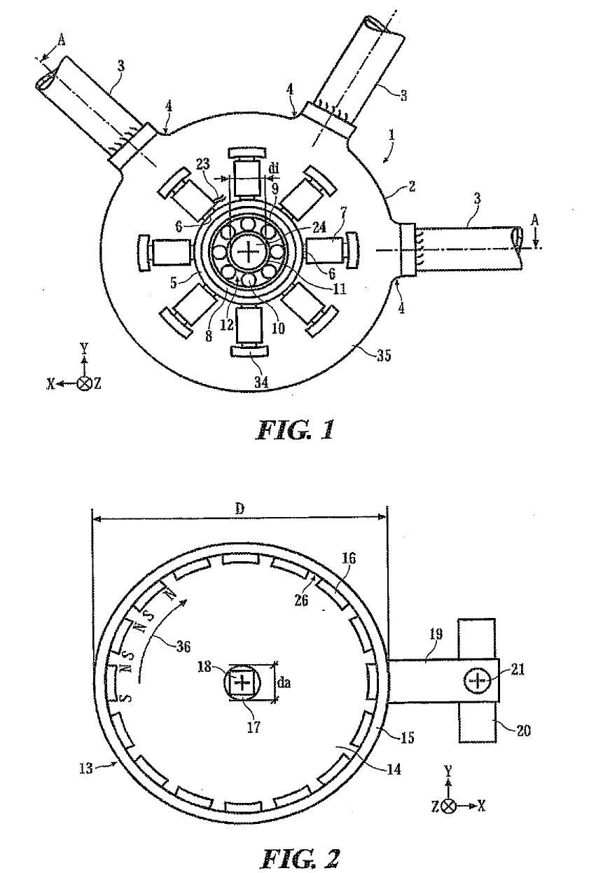

FIG. 1 diagrammatically shows a view from above onto the stator of an electric motor according to the invention for a bicycle according to a first embodiment;

FIG. 2 diagrammatically shows a view from above onto the rotor of an electric motor according to the invention;

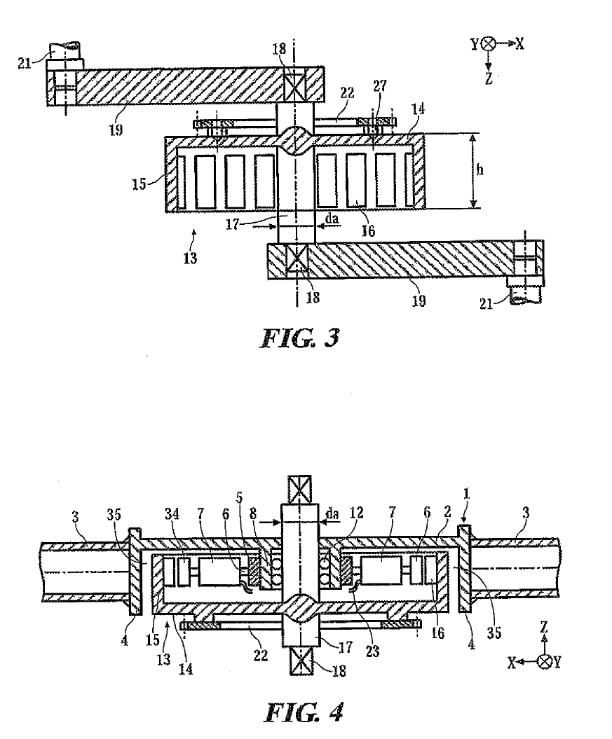

FIG. 3 diagrammatically shows a cross-section through the rotor of an electric motor according to the invention;

FIG. 4 diagrammatically shows a cross-section through the electric motor according to the invention and according to the first embodiment;

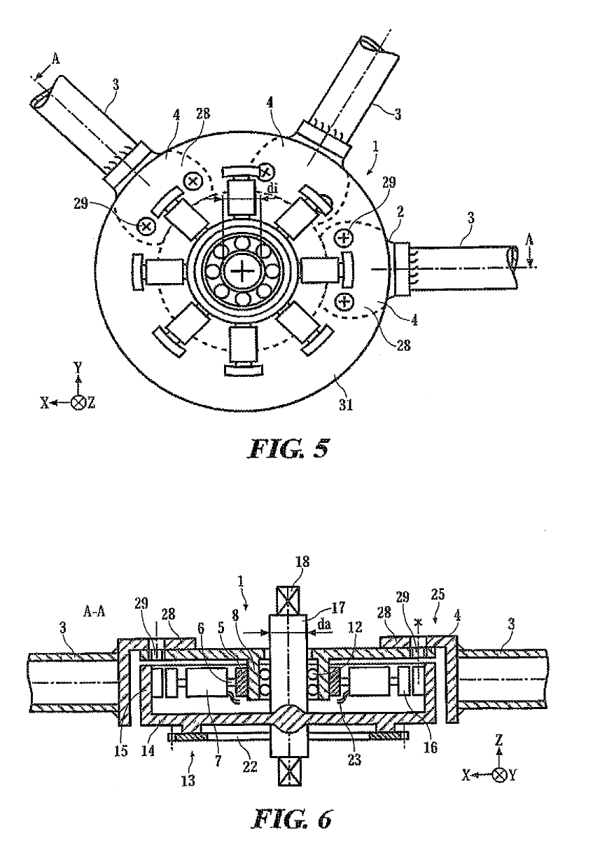

FIG. 5 diagrammatically shows a view from above onto the stator of an electric motor according to the invention according to a second and third embodiment of the electric motor according to the invention;

FIG. 6 diagrammatically shows a view in cross-section through the rotor of an electric motor according to the invention;

FIG. 7 diagrammatically shows a view in cross-section through a third embodiment of the electric motor according to the invention; and

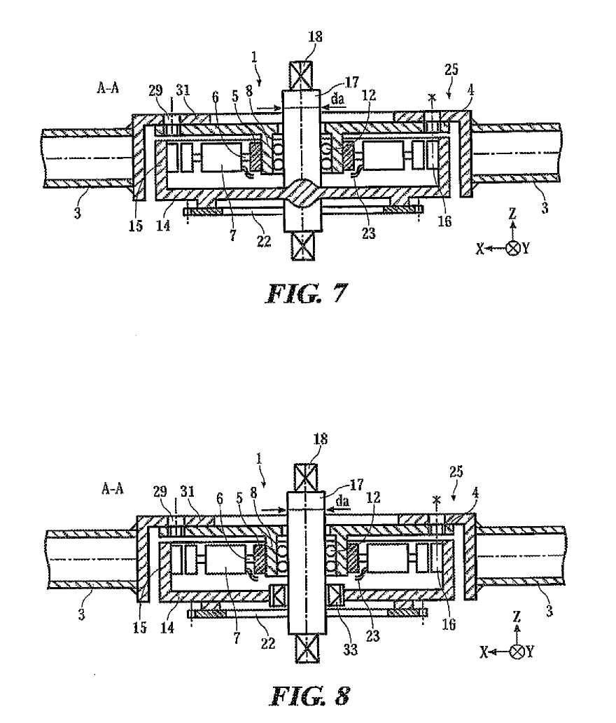

FIG. 8 diagrammatically shows a view in cross-section through an alternative embodiment of the electric motor according to the invention.

FIGS. 1 to 4 diagrammatically show an electric motor according to a first embodiment of the invention.

The stator 1 of the external-rotor electric motor according to the invention, that is shown diagrammatically in FIG. 1 in a top view, has a plate 2 which is in this embodiment an integral component of the frame of a bicycle that is not shown in detail, of which only sections of three frame tubes 3 are shown in FIG. 1. The plate 2 has, on its outside edge, areas 4 that are provided for fastening to the frame tubes 3. In this embodiment, each area 4 is formed as a rectangular flange bearing.

The inside of the plate 2 of the stator 1 has a bearing support 8 having a ball bearing 12. The ball bearing 12 comprises an outer ring 9, an inner ring 11, and balls 10 arranged between the outer ring 9 and the inner ring 11. The opening 24 is provided for engagement of a drive shaft that is not shown in FIG. 1. dᵢ can be 20 mm, for example.

The bearing support 8 of the stator 1 is enclosed by the base ring 5 that carries the yokes 6 of the stator 1. The yokes 6 are each provided with coils 7 that are supplied with current by supply lines 23 that are shown only diagrammatically here. The yokes 6 with the coils 7 extend outward radially from the base ring 5 and have yoke connections 34 connecting radially to the coils 7. A running area 35 for the rotor of the electric motor that is not shown in FIG. 1 connects to the yoke ends.

Only a few yokes 6 are shown in the figure. For smooth running of the bicycle and for producing high torque, however, a far greater number of yokes 6 with coils 7 are provided.

FIG. 2 diagrammatically represents a view from above onto the rotor 13 of the electric motor according to the invention. The rotor 13 has a cuplike shape with a floor 14 and an edge 15. The rotor 13 has a diameter D with 250 mm ≦D≦350 mm.

A number of permanent magnets 16 are arranged on the inside 26 of the edge 15. The permanent magnets 16 are arranged such that their polarity changes in the direction of the circumference of the rotor 13, indicated by the arrow 36.

The rotor 13 in this embodiment is arranged fixedly on the drive shaft 17 of the bicycle, and can be realized also in one piece with the drive shaft 17. Thereby, the drive shaft 17 has a diameter dₐ that can be 20 mm, for example. At each of its ends, the drive shaft 17 has rectangular connections 18 for mounting a crank 19 for a pedal 20. Therein, the pedals are affixed to the cranks 19 using a fastening element 21, such as a screw.

FIG. 3 shows a cross-section through the rotor 13. In this illustration it can be seen that the rotor 13 has a height h that is typically 30 to 60 mm.

In this illustration it can also be seen that the rotor 13 in the area of its floor 14 has a sprocket wheel 22 for engaging a chain that is not shown. The pinion 22 can be screwed on in this embodiment with the floor 14 of the rotor 13. Threaded holes 27 are provided for this purpose.

FIG. 4 diagrammatically shows a cross-section along the line A-A of FIG. 1, whereby in this representation not only the stator 1 but also the rotor 13 is shown. The rotor 13 is arranged so that the drive shaft 17 extends through the opening 24 in the inner ring 11 of the ball bearing 12 and is mounted in the ball bearing 12 which is shown here only symbolically. Therein, the diameter d, of the central hole 24 is substantially equivalent to the diameter dₐ of the drive shaft 17.

The edge 15 of the rotor 13 that is populated with the permanent magnets 16 is arranged in the running area 35 of the stator 1, which connects radially to the yoke ends 34 of the stator 1. The permanent magnets 16 of the rotor 14 are situated opposite to the yoke ends 34 of the yokes 6 with the coils 7.

The following procedure is followed for assembling the electric motor according to the invention: The plate 2 of the stator 1 is affixed in the areas 4 provided therefore in the frame of the bicycle by welding it, as shown in this exemplary embodiment, to the frame tubes 3, for example. Then the ball bearing 12 is mounted in the bearing support 8 and the yokes 6 are connected to the yoke ends 34 and the coils 7 are connected to the base ring 5 of the bearing support 8.

In addition, the rotor 13 is connected to the permanent magnets 16 arranged on the inside of its edge 15. The rotor 13 is inserted into the stator 1, which is cup-shaped in this embodiment, and connected to same by introduction of the drive shaft 17 into the opening 24 in the inner ring 11, to the ball bearing 12. When this is done, the edge 15 is aligned with the permanent magnets 16 in the running area 35 of the stator. Then the cranks 19 are mounted with the pedals 20 on the drive shaft 17.

It is also possible to initially assemble the electric motor 25 by inserting the rotor 13 into the stator 1 and only then to connect it to the frame tubes 3. In particular, this is possible when the connection of the plate 2 of the stators 1 to the frame tubes 3 is done by means of screws and not by welding.

In operation, current flows through the coils 7 and produces a magnetic field, which produces a torque by means of the interaction with the permanent magnets 16 of the rotors 13. To do this, the voltage producing the current by means of the coils is switched at any instant such that the permanent magnets 16 are attracted by the yoke connection 24 following in the sense of the circumference of the rotor 13, whereas they are repelled by the just-passed yoke end 34.

An electronic commutator can be used for switching the supply voltage for the coils (7). Triggering the voltage is done contactless in this instance by means of a Hall sensor or by analysis of induction currents in the coils, for example.

The torque is transmitted to the wheels of the bicycle over the sprocket wheel 22 mounted fixedly on the rotor 13, using a chain that is not shown. In an embodiment which is not shown in place of a sprocket wheel a toothed belt disk is provided and in place of a chain, a toothed belt.

Moreover, the bicycle with the electric motor 25 according to the invention can, however, also be driven by the rider using the pedals 20 mounted on the drive shaft 17. Both the electric motor 25 and the pedals 20 thereafter engage on the same drive shaft 17 and therefore require only a single, common chain or a toothed belt for transmission of the torque.

FIG. 5 shows a diagrammatic view from above onto a second or, respectively, a third embodiment of the stator 1 of the electric motor according to the invention. In this embodiment, the plate 2 of the stator 1 is not welded directly to the frame tube 3. Instead, mounting plates 28 are welded to the frame tube 3, which is only indicated by broken lines in FIG. 5. Instead of separate mounting plates 28 for each frame tube 3, a common mounting ring 31, which is indicated in FIG. 5 using broken lines as well, or another type of common mounting plate can also be provided. Therein, a common mounting ring 31 or another configuration of common mounting plate has the advantage that the frame of the bicycle is connected and self-supporting even without the electric motor.

The plate 2 of the stator 1 has areas 4 for fastening to the mounting plates 28 or to the mounting ring 31 of the frame, whereby the areas 4 in this embodiment are realized as plates and exhibit holes 29 for receiving fastening elements, such as screws.

FIG. 6 shows the electric motor 25 according to FIG. 5 in cross-section along the line A-A. The second embodiment is shown in which the plate 2 of the stator 1 is affixed in its areas 4 to separate mounting plates 28 of the frame tube 3.

The third embodiment of the electric motor 25 with a common mounting ring 31 is shown diagrammatically in cross-section in FIG. 7. The mounting ring 25 is affixed to the plate 2 of the stator 1 similar to the mounting plates 28 in the second embodiment. Again, holes 29 are provided for receiving fastening elements such as screws.

FIG. 8 diagrammatically shows in cross-section an alternative embodiment of the electric motor 25 In this embodiment, the rotor has a free-wheeling device 33 with blocking blades or clamp rollers. This embodiment has the advantage that continuous pedaling of a rider is not required. In this embodiment, because of the free-wheeling 33, it is not necessary for the rider to continuously operate the pedals, but the rotation of the drive wheel 17 can also be disengaged from the movement of the rotor 13, such that the drive of the bicycle occurs solely via the electric motor 25, without the support of the rider.

In the exemplary embodiments described above, the following reference numbers are used:
1 Stator
2 Plate
3 Frame tube
4 Areas
5 Base ring
6 Yoke
7 Coils
8 Bearing support
9 Outer ring
10 Balls
11 Inner ring
12 Ball bearings
13 Rotor
14 Base
15 Edge
16 Permanent magnet
17 Drive shaft
18 Rectangular connection
19 Crank
20 Pedals
21 Fastening element
22 Sprocket wheel
23 Supply
24 Opening in the inner ring
25 Electric motor
26 Inside
27 Threaded hold
28 Mounting plate
29 Hole
31 Mounting ring
33 Free-wheeling device
34 Yoke end
35 Running area
dₐ External diameter of the crank 10
dᵢ Inner diameter of the central hole
D Diameter of the rotor
h Height of the rotor

The exemplary embodiments can also be described using the following explanations and features according to numerals 1 to 20, wherein emphasis is placed on the combinations of features resulting from the corresponding back references.

1. Electric motor (25) for a motor vehicle having:
a stator (1) with predefined areas (4) for a connection to a vehicle frame;
a rotor (13) with predefined areas for receiving a driving means, wherein the rotor (13) is arranged on a drive shaft (17) that is mounted rotatably in the stator (1);
the electric motor (25) is realized as an external-rotor motor.

2. Electric motor (25) according to numeral 1,

wherein the electric motor (25) can be realized as an electronically commutated d.c. external-rotor motor.

3. Electric motor (25) according to numeral 1 or 3,

wherein the electric motor (25) is realized brushless and the rotor (13) has a number of permanent magnets (16).

4. Electric motor (25) according to one of numbers 1 to 3,

wherein the areas for receiving a driving means is realized as sprocket wheel (22).

5. Electric motor (25) according to one of numerals 1 to 3,

wherein the area for receiving a driving means is realized as a toothed belt disk.

6. Electric motor (25) according to one of numerals 1 to 5,

wherein cranks (19) with pedals (20) can be affixed to the ends of the drive shaft (17).

7. Electric motor (25) according to one of numerals 1 to 6,

wherein the areas for receiving the driving means are screwed onto the rotor (13).

8. Electric motor (25) according to one of numerals 1 to 7,

wherein the drive shaft (17) has a free-wheeling device (33) in a transitional area to the rotor (13).

9. Electric motor (25) according to one of numerals 1 to 8,

wherein the rotor (13) has a diameter D with 250 mm ≦D≦350 mm.

10. Electric motor (25) according to one of numerals 1 to 9, 1

wherein the rotor (13) has a height h of 30 mm ≦h≦60 mm.

11. Motor vehicle with an electric motor (25) according to one of numerals 1 to 10,

wherein the stator (1) of the electric motor (25) is connected to frame tubes (3) of the motor vehicle and the drive shaft is connected by a driving means to a wheel of the motor vehicle.

12. Motor vehicle according to numeral 11,

wherein the motor vehicle is realized as a bicycle.

13. Motor vehicle according to numeral 11 or 12,

wherein the driving means is realized as a chain.

14. Motor vehicle according to numeral 11 or 12,

wherein the driving means is realized as a toothed belt.

15. Motor vehicle according to one of numerals 11 to 14,

wherein the electric motor (25) is welded to frame tubes (3) of the vehicle.

16. Motor vehicle according to one of numerals 11 to 14,

wherein the electric motor (25) is connected by screws to frame tubes (3) of the vehicle.

17. Method for operating a motor vehicle with an electric motor (25) realized as an external-rotor motor that comprises the following steps:
Provision of a stator (1) of the electric motor (25) with coils for generating magnetic fields, wherein the coils (7) have connections (23) for a supply voltage;
Provision of a rotor (13) of the electric motor (25) with permanent magnets, wherein the permanent magnets (16) are situated radially opposite the coils (7) with reference to a drive shaft (17).
The supply voltage is switched so that the magnetic field generated by means of the current flowing through the coils (7) exercises a force of attraction on the permanent magnets (16) of the rotor (13) and thus exercises torque on the rotor (13).

18. Motor vehicle according to numeral 17,

wherein an electronic commutator is used for switching the supply voltage.

19. Motor vehicle according to numeral 18,

wherein the supply voltage is triggered by a Hall sensor.

20. Motor vehicle according to numeral 18,

wherein the supply voltage is triggered by evaluating induction currents in the coils (7).

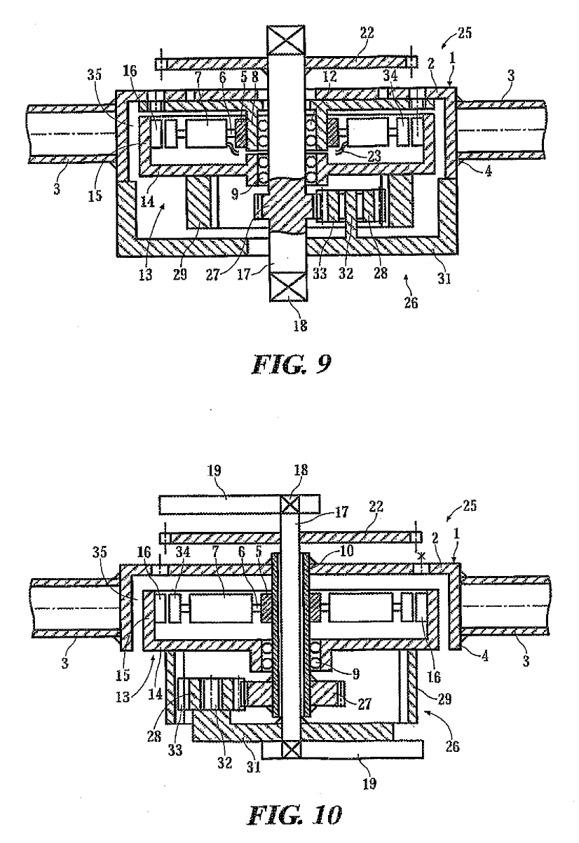

FIG. 9 diagrammatically represents a cross-section through the electric motor according to the invention for a motor vehicle according to a first embodiment:

FIG. 10 diagrammatically represents a cross-section through the electric motor according to the invention for a motor vehicle according to a second embodiment:

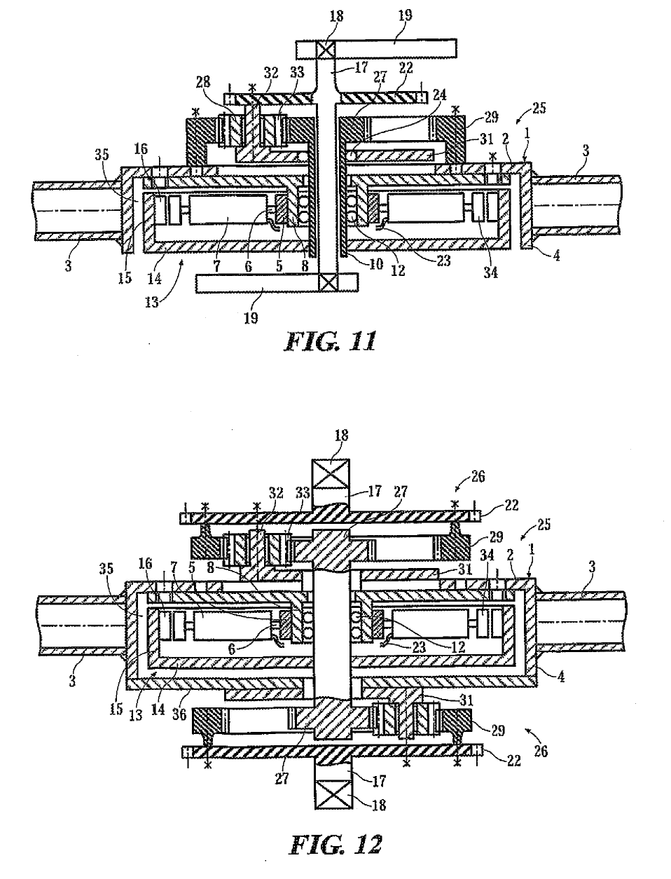

FIG. 11 diagrammatically represents a cross-section through the electric motor according to the invention for a motor vehicle according to a third embodiment:

FIG. 12 diagrammatically represents a cross-section through the electric motor according to the invention for a motor vehicle according to a fourth embodiment:

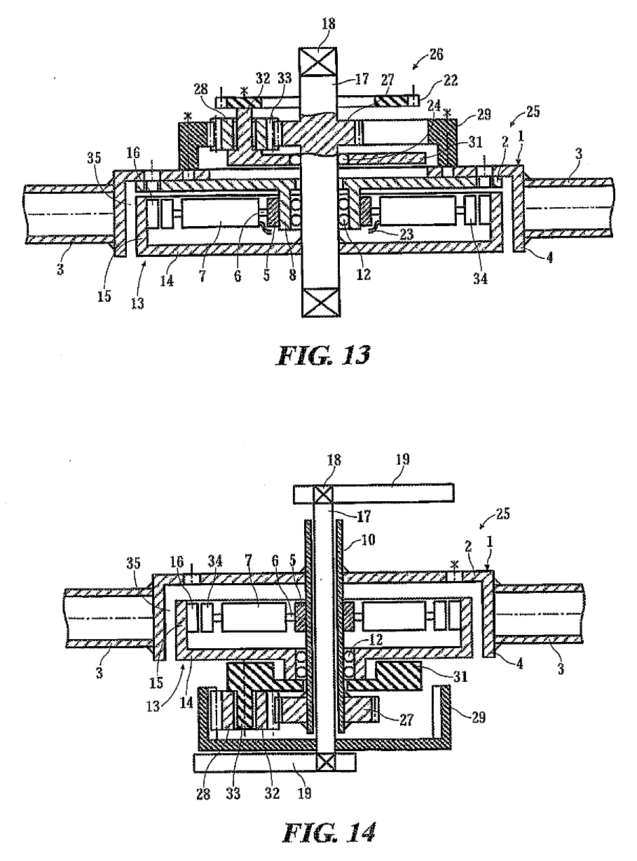

FIG. 13 diagrammatically represents a cross-section through the electric motor according to the invention for a motor vehicle according to a fifth embodiment:

FIG. 14 diagrammatically represents a cross-section through the electric motor according to the invention for a motor vehicle according to a sixth embodiment:

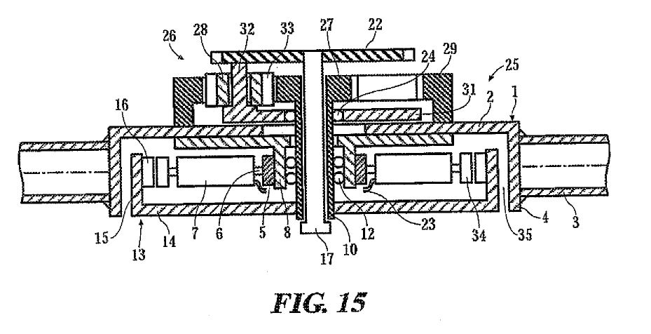

FIG. 15 diagrammatically represents a cross-section through the electric motor according to the invention for a motor vehicle according to a seventh embodiment:

Inasmuch as the electric motor of FIGS. 1 and 2 is used with gears for the exemplary embodiments, the following description is particularly helpful. The FIGS. 1 and 2 illustrate the principle of the stator and the rotor of the electric motor according to the invention. In the interest of clarity, the planetary gear, that are also part of the electric motor according to the invention, is not shown.

The stator 1 of the external-rotor electric motor according to the invention that is shown diagrammatically in FIG. 1 in a top view, has a plate 2 that is in this embodiment an integral component of the frame of a bicycle (not shown in detail), of which only sections of three frame tubes 3 are shown in FIG. 1. The plate 2 has on its outside edge areas 4 that are provided for fastening to the frame tubes. In this embodiment, each area 4 is formed as a rectangular flange bearing.

The inside of the plate 2 of the stator 1 has a bearing support 8 having a ball bearing 12. The ball bearing 12 comprises an outer ring 9, and inner ring 11, and balls 10 arranged between the outer ring 9 and the inner ring 11. The opening 24 is provided for engagement of a drive shaft (not shown in FIG. 1). d, can be 20 mm, for example.

The bearing support 8 of the stator 1 is encircled by an base ring 5 that supports the yoke 6 of the stator 1. The yokes 6 are each provided with coils 7 that are supplied by supply lines 23 (shown here only diagrammatically) with current. The yokes 6 with the coils 7 extend radially from the base ring 5 outward and have yoke connections 34 connecting radially to the coils 7. A running area 35 for the rotor of the electric motor (not shown in FIG. 1) connects to the yoke ends.

Only a few yokes 6 are shown in the FIG. 1. For smooth running of the bicycle and for producing high torque, however, a far greater number of yokes 6 are provided with coils 7.

FIG. 2 diagrammatically represents a view from above onto the rotor 13 of the electric motor according to the invention. The rotor 13 has a cuplike shape with a floor 14 and an edge 15. The rotor 13 has a diameter D with 250 mm ≦D≦350 mm.

A number of permanent magnets 16 are arranged on the inside 26 of the edge 15. The permanent magnets 16 are arranges so that their polarity changes in the direction of the circumference of the rotor 13, indicated by the arrow 36.

In this embodiment, the rotor 13 is supported on the drive shaft 17 of the bicycle.

There the drive shaft 17 has a diameter that can be 20 mm, for example. At each of its ends the drive shaft 17 has rectangular connections 18 for mounting a crank 19 for a pedal 20. Obviously, in lieu of the rectangular connection 18 a hexagonal connection or a multiple connection or the like can be used. Here, the pedals are affixed to the cranks 19 using a fastening element 21 such as a screw.

FIGS. 9 to 15 diagrammatically represent different embodiments of an electric motor according to the invention.

FIG. 9 diagrammatically represents a cross-section through a first embodiment of the electric motor 25 having the rotor 13 and stator 1 described in conjunction with FIGS. 1 and 2.

The electric motor 15 has a planetary gear mechanism 26 that is organized into a sun wheel 27, planet wheels 28 connected via a planetary carrier 31 and a ring gear (annulus gear) 29. In the view shown in FIG. 3 only one planet wheel 28 can be seen; several can be present, however.

In the embodiment shown in FIG. 9 the planetary carrier 31 is fixedly connected to the stator 1 of the electric motor 25. Accordingly the center 32 of the planet wheel 28 is at rest with reference to the stator 1. The gear rim 33 of the planet wheel 28 is supported on the center 32, the sun wheel 27 engages in the gear rim 33, which is fixedly mounted on the drive shaft 27. The annulus gear in which the gear rim 33 also engages, is fixedly connected to the base 14 of the rotor 13.

The following procedure is followed exemplarily for assembling the electric motor according to the invention: The plate 2 of the stator 1 is affixed in the areas 4 provided therefore in the frame of the bicycle in which, as shown in this exemplary embodiment, it is welded to the frame tubes 3, for example. Then the ball bearing 12 is mounted in the bearing support 8 and the yokes 6 are connected to the yoke ends 34 and the coils 7 are connected to the base ring 5 of the bearing support 8.

In addition, the rotor 13 with the permanent magnets 16 mounted on the inside of the edge 15 is provided with the annulus gear 29 connected to the base. The rotor 13, is inserted into the cup-shaped stator 1 of this embodiment and connected to it by inserting the drive shaft 17 with the sun wheel 27 fixedly connected to the drive shaft 17 into the opening in the inner ring to the ball bearing 12 and to the ball bearing 9 of the rotor 13. When this is done the edge 15 comes to lie with the permanent magnets 16 in the running area 35 of the stator. Finally, the planetary carrier 31 is inserted with the planet wheels 28 between the annulus gear 29 and sun wheel 27, and the planetary carrier 31 is fixedly connected to the stator 1.

Then the cranks are mounted with the pedals on the drive shaft 17.

It is also possible to assemble the electric motor 25 initially by inserting the rotor 13 into the stator 1 and only then to connect it to the frame tubes 3. This is particularly possible when the connection of the plate 2 of the stator 1 to the frame tubes 3 is done by using screws and not by welding.

In operation current flows through the coils 7 and produces a magnetic field, which produces a torque by means of the interaction with the permanent magnets 16 of the rotors 13. To do this the voltage producing the current by means of the coils is switched at any instant so that the permanent magnets 16 are attracted by the yoke connection 24 following in the sense of the circumference of the rotor 13, whereas they are repelled by the just-passed yoke end 34.

An electronic commutator can be used for switching the supply voltage for the coils 7.

Triggering the voltage is done contactless in this instance by means of a Hall sensor or by analysis of induction currents in the coils, for example.

In this fashion the rotor 13 produces a rotary movement that is transmitted by the coincidentally rotating ring gear 29 via the planet wheels 28 and the sun wheel 27 to the drive shaft 17. A bicycle rider can transmit a torque likewise to the drive shaft 17 by means of the pedals.

The torque is then transmitted via the sprocket wheel 22 mounted fixedly on the drive shaft 17, by means of a chain (not shown), to the wheels of the bicycle. In one embodiment (not shown) a toothed belt wheel instead of a sprocket wheel, and instead of a chain a toothed belt is provided. In this and the remaining embodiments, a free-wheeling device with spring catches or clamp rollers can be provided. This has the advantage that, because of the free-wheeling 15, it is unnecessary for the rider to continuously operate the pedals but the rotation of the drive shaft 17 can also be disengaged from the movement of the pedals, so that the driving of the bicycle occurs solely via the electric motor 25, without the support of the rider.

In this embodiment it can be advantageous to select the speed of the annulus gear 29 and thus of the rotor 13 higher than that of the drive shaft 17. In a normal pedaling cadence of the rider it is thus possible to operate the electric motor 25 at a higher frequency than the pedaling cadence. In many applications it can be advantageous, however, in this and in the other embodiments, to achieve a reverse transmission by means of the planetary gear, so that the electric motor can be operated at a frequency that is lower than the pedaling cadence. When this is done, the desired relationship of the frequencies can be very flexibly adjusted by means of an appropriate selection of the diameter of the sun wheel 27, planet wheel 28, and annulus gear 29.

In addition, it is advantageous that the planet gear 26 in this embodiment is of a particularly simple construction and is thus light and robust and has a high efficiency.

FIG. 10 shows a second embodiment of the electric motor 25 according to the invention. This embodiment differs from the first embodiment in virtue of the arrangement of the elements forming the planetary gear mechanism 26. In this embodiment the sun wheel 27 is connected by welding seams 11 to a hollow shaft 10, which is in turn welded to the base 2 of the stator 1. The base ring 5 for the yoke 6 is also fixedly connected to the hollow shaft 10. Consequently, in this embodiment the sun wheel 27 is at rest in the system of the stator 1.

The rotor 13 is supported by means of the ball bearing 9 on the hollow shaft and otherwise constructed as in the first exemplary embodiment. The base 14 of the rotor 13 is fixedly connected to the annulus gear 29.

The planet wheel 28, which with its center 32 is supported rotatably on the planetary carrier 31, engages in the annulus gear 29 and the sun wheel. The planetary carrier 31 is fixedly connected to the drive shaft 17. Thus the planetary carrier 31 transmits its rotary movement directly to the drive shaft 17 on which, in turn, cranks 19 for pedals are affixed. When operating this embodiment of the bicycle, the annulus gear 29, which is fixedly connected to the rotor 13, rotates at the same frequency, at which the rotor 13 rotates. The planet wheel 28 that rolls between the annulus gear 29 and the stationary sun wheel 27, transmits the torque to the planetary carrier 31, at which the torque is picked up via the connection with the drive shaft 17. A sprocket wheel 22 is mounted on the drive shaft 17, which transmits the torque by means of a driving means (not shown) further to the wheels of the bicycle.

In this embodiment it is particularly advantageous that the rotation speed of the annulus gear 29 and thus of the rotor 13 is greater than that of the planetary carrier 31, and consequently of the drive shaft 17. With a normal pedaling cadence of the rider it is thus possible in this embodiment, too, to operate the electric motor 25 at a higher frequency than the pedaling cadence. When this is done, the desired relationship of the frequencies can be very flexibly adjusted by means of an appropriate selection of the diameter of the sun wheel 27, planet wheel 28, and annulus gear 29. It is further advantageous that because of the elimination of the ball bearing 12 there is more space for the stator, so that the yoke 6 can be designed longer and with more coils 27.

FIG. 11 shows a third embodiment of the electric motor 25 according to the invention. This embodiment differs from the first and the second embodiment in virtue of the arrangement of the elements forming the planetary gear mechanism 26. In this embodiment, as in the first embodiment, the annulus gear 29 is fixedly connected to the stator 1 and consequently at rest in the stator 1 system.

The sun wheel 27 is fixedly connected to a hollow shaft 10 or realized in one piece with it. The hollow shaft 10 in turn is fixedly connected to the base 14 of the rotor 13. The sun wheel 27 thus rotates at the rotor 13 frequency.

The drive shaft 17 is rotatably mounted in the hollow shaft 10 that is connected to the planetary carrier 31 via the sprocket wheel 22. The planetary carrier 31 is supported on the hollow shaft 10 by means of a ball bearing 24. Consequently, in this embodiment the torque is picked up at the planetary carrier 31, as in the second embodiment.

In this embodiment it is advantageous that the rotation speed of the sun wheel 27 and thus of the rotor 13 is greater than that of the planetary carrier 31, and consequently of the drive shaft 17. With a normal pedaling cadence of the rider it is thus possible in this embodiment, too, to operate the electric motor 25 at a higher frequency than the pedaling cadence. When this is done, the desired relationship of the frequencies can be very flexibly adjusted by means of an appropriate selection of the diameter of the sun wheel 27, planet wheel 28, and annulus gear 29.

FIG. 12 shows a fourth embodiment of the electric motor 25 according to the invention. This embodiment differs from the previously described embodiments in virtue of the arrangement of the elements forming the planetary gear mechanism 26. In this embodiment a planetary gear mechanism 26 is arranged symmetrically on both sides of the electric motor 25. In addition, the stator 1 has a cover situated opposite the base 2.

In this embodiment, the planetary carrier 31 is fixedly connected to the base 2 or the cover 36 of the stator, and consequently at rest in the stator 1 system. The sun wheel 27 is fixedly connected to the base 14 of the rotor 13 and thus rotates with the same frequency as the rotor 13. The drive shaft 17 is not formed in one piece in this embodiment but interrupted on each side for the planetary gear mechanism 26. The sun wheel 27 engages on each side of the gear rim 33 of the planet wheel 28 so rolls in the annulus gear 29. The annulus gear 29 is fixedly connected to the sprocket wheel 22.

In this embodiment it is advantageous that the rotation speed of the sun wheel 27 and thus of the rotor 13 is greater than that of the planetary carrier 31, and consequently of the drive shaft 17. With a normal pedaling cadence of the rider it is thus possible in this embodiment, too, to operate the electric motor 25 at a higher frequency than the pedaling cadence. When this is done, the desired relationship of the frequencies can be very flexibly adjusted by means of an appropriate selection of the diameter of the sun wheel 27, planet wheel 28, and annulus gear 29.

In addition, the electric motor 25 and especially the planetary gear mechanism 26 in this embodiment are naturally relatively complex but also symmetrically designed and accordingly well balanced.

FIG. 13 shows a fifth embodiment of the electric motor 25 according to the invention. This embodiment differs from the previously described embodiments in virtue of the arrangement of the elements forming the planetary gear mechanism 26. In this embodiment the annulus gear 29 is fixedly connected to the stator 1 and consequently at rest in the stator 1 system.

The sun wheel 27 is fixedly connected to a drive shaft 17 or realized in one piece with it. The drive shaft 17 is fixedly connected to the base 14 of the rotor 13 and thus rotates with the same frequency as the rotor 13.

A sprocket wheel 22 is mounted on the planetary carrier 31 or on the center 32 of the planet wheel 28, by way of which the torque is transmitted by means of a driving means (not shown) to the wheels of the bicycle.

In this embodiment it is advantageous that the planetary gear mechanism is particularly simple and thus constructed light and robust. The rotor 13 is connected fixedly to the drive shaft 17 on which the cranks with pedals for the rider (not shown) are shown. Accordingly, the pedaling cadence of the rider in this embodiment corresponds to the frequency of the rotor 13.

In virtue of the connection of the sprocket wheel 22 to the center 32 of the planet wheel 28 and thus with the planetary carrier 31, a gear reduction occurs between the sun wheel 27 and the sprocket wheel 22, which can be adjusted by a suitable choice of the diameter of sun wheel 27, planet wheel 28, and annulus gear 29.

FIG. 14 shows a sixth embodiment of the electric motor 25 according to the invention. This embodiment differs from the previously described embodiments in virtue of the arrangement of the elements forming the planetary gear mechanism 26. In this embodiment, the sun wheel 27 is fixedly connected to a hollow shaft 10 or realized in one piece with it. The hollow shaft 10 itself is fixedly connected to the base 2 of the rotor 1. The sun wheel 27 is consequently at rest in the system of the stator 1.

The rotor 13 is supported on the hollow shaft 10 by means of a ball bearing 9. The base 14 of the rotor 13 is fixedly connected to the planetary carrier 31.

The planet wheel 28 engages with the annulus gear 29 and the sun wheel, which with its center 32 is supported rotatably on the planetary carrier 31. The ring gear 29 is fixedly connected to the drive shaft 17. Consequently the rotor 13 transmits its rotary movement via the planetary carrier 31 to the planet wheel 28, which in turn engages with the stationary sun wheel 27 and in the annulus gear 28, and consequently acts via the annulus gear 29 on the drive shaft 17.

The sprocket wheel (not shown in this figure) can, for example, be affixed externally on the annulus gear 29 or mounted directly on the drive shaft 17.

In this embodiment either the rotor 13 frequency corresponds to that of the annulus gear 29 and thus the pedaling cadence of the rider, or, if the sprocket wheel is mounted on the planet wheel 28, the frequency of the rotor is less than the pedaling cadence of the rider. In the latter case the electric motor is suitable only for special applications.

The advantage of the sixth embodiment is that as in the second embodiment ample space is available for the rotor 13 and consequently the yokes 6 with the windings 7 can be designed particularly amply.

FIG. 15 diagrammatically represents a cross-section through the electric motor according to the invention for a motor vehicle according to a sixth embodiment, which corresponds substantially to the third embodiment according to FIG. 5. The difference resides in that the drive shaft 17 is slightly shortened and is not provided for receiving cranks with pedals. In this embodiment the electric motor is particularly suited for driving a motorcycle. Of course, other embodiments such as, for example, those according to FIGS. 12 to 14 are suitable for use in a motorcycle, which does not have cranks with pedals.

In the exemplary embodiments with gears described above, the following reference numbers are used:
1 Stator
2 Plate
3 Frame tube
4 Areas
5 Base ring
6 Yoke
7 Coils
8 Bearing support
9 Ball bearings
10 Hollow shaft
11 Weld seam
12 Ball bearings
13 Rotor
14 Base
15 Edge
16 Permanent magnet
17 Drive shaft
18 Rectangular connection
19 Crank
Pedals
21 Fastening element
22 Sprocket wheel
23 Supply
24 Ball bearings
25 Electric motor
26 Planetary gear
27 Sun wheel
28 Planet wheel
29 Ring gear
31 Planetary carrier
32 Center
33 Rear rim
34 Yoke end
Running range
36 Cover

The exemplary embodiments with gears can also be described using the following explanations and features according to numbers 1 to 38, wherein emphasis is placed on the combinations of features resulting from the corresponding back references.

1. Electric motor (25) for a motor vehicle having:
a stator (1) with predefined areas (4) for a connection to a vehicle frame;
a rotor (13);
predefined areas for receiving a driving means;
a planetary gear mechanism (26);
the electric motor (25) is realized as an external-rotor motor.

2. Electric motor according to numeral 1,

wherein the rotor (13) is arranged on a drive shaft (17), that is rotatably mounted in the stator (1).

3. Electric motor according to numeral 2,

wherein the drive shaft (17) is mounted in a hollow shaft (10).

4. Electric motor (25) according to numeral 2 or 3,

wherein cranks (19) with pedals (20) can be affixed to the ends of the drive shaft (17).

5. Electric motor (25) according to one of numbers 1 to 4,

wherein the drive shaft (17) has a free-wheeling device (33) in a transitional area to the rotor (13).

6. Electric motor (25) according to one of numerals 1 to 5,

wherein a planetary carrier (31) of the planetary gear mechanism (26) is fixedly connected to the stator (1).

7. Electric motor according to numeral 6,

wherein an annulus gear (29) of the planetary gear mechanism (26) is fixedly connected to the rotor (13).

8. Electric motor according to numeral 6,

wherein a sun wheel (27) of the planetary gear mechanism (26) is fixedly connected to the rotor (13).

9. Electric motor according to one of numerals 1 to 5,

wherein a sun wheel (27) of the planetary gear mechanism (26) is fixedly connected to the stator (1).

10. Electric motor according to numeral 9,

wherein an annulus gear (29) of the planetary gear mechanism (26) is fixedly connected to the rotor (13).

11. Electric motor according to numeral 9,

wherein a planetary carrier (31) of the planetary gear mechanism (26) is fixedly connected to the rotor (13).

12. Electric motor according to one of numerals 1 to 5,

wherein an annulus gear (29) of the planetary gear mechanism (26) is fixedly connected to the stator (1).

13. Electric motor according to numeral 12,

wherein a sun wheel (27) of the planetary gear mechanism (26) is fixedly connected to the rotor (13).

14. Electric motor according to numeral 12,

wherein a planetary carrier (31) of the planetary gear mechanism (26) is fixedly connected to the rotor (13).

15. Electric motor (25) according to one of numerals 1 to 14, 21

wherein the electric motor (25) can be realized as an electronically commutated d.c. external-rotor motor.

16. Electric motor (25) according to one of numbers 1 to 15,

wherein the electric motor (25) is realized brushless and the rotor (13) has a number of permanent magnets (16).

17. Electric motor (25) according to one of numbers 1 to 16,

wherein the areas for receiving a driving means are realized as sprocket wheel (22).

18. Electric motor (25) according to one of numbers 1 to 16,

wherein the area for receiving a driving means are realized as toothed belt disks.

19. Electric motor (25) according to one of numbers 1 to 16,

wherein the area for receiving a driving means are realized as cardan pinions.

20. Electric motor (25) according to one of numbers 17 to 19,

wherein the areas for receiving the driving means are fixedly fastened to the drive shaft (17) or to areas of the planetary gear mechanism (26).

21. Electric motor (25) according to one of numbers 1 to 20,

wherein the rotor (13) has a diameter D with 250 mm ≦D≦350 mm.

22. Electric motor (25) according to one of numbers 1 to 21,

wherein the rotor (13) has a height h of 30 mm ≦D≦60 mm.

23. Motor vehicle having an electric motor (25) according to one of numbers 1 to 22, wherein the stator (1) of the electric motor (25) is connected to frame tubes (3) of the motor vehicle and a sprocket wheel (22) of the electric motor (25) is connected by a driving means to a wheel of the motor vehicle.

24. Motor vehicle according to numeral 23,

wherein the motor vehicle is realized as a bicycle.

25. Motor vehicle according to numeral 23,

wherein the motor vehicle is realized as a motorcycle.

26. Motor vehicle according to one of numerals 23 to 25,

wherein the driving means is realized as a chain.

27. Motor vehicle according to one of numerals 23 to 25,

wherein the driving means is realized as a toothed belt.

28. Motor vehicle according to one of numerals 23 to 27,

whereby the sprocket wheel (22) is fixedly connected to a drive shaft (17).

29. Motor vehicle according to one of numerals 23 to 28,

wherein the sprocket wheel (22) is fixedly connected to a planetary carrier (31) of the planetary gear mechanism (26). 22

30. Motor vehicle according to one of numerals 23 to 28,

wherein the sprocket wheel (22) is fixedly connected to an annulus gear (29) of the planetary gear mechanism (26).

31. Motor vehicle according to one of numerals 23 to 28,

wherein the sprocket wheel (22) is fixedly connected to a sun wheel (27) of the planetary gear mechanism (26).

32. Motor vehicle according to one of numerals 23 to 31,

wherein the electric motor (25) is welded to frame tubes (3) of the vehicle.

33. Motor vehicle according to one of numerals 23 to 32,

wherein the electric motor (25) is connected by screws to frame tubes (3) of the vehicle.

34. Motor vehicle according to one of numerals 23 to 33,

wherein the motor vehicle has a wheel suspension with a rocker arm that is mounted on the motor vehicle rotatably around an axis of rotation, wherein the axis of rotation of the rocker arm corresponds substantially to the axis of rotation of the rotor (13).

35. Method for operating a motor vehicle with an electric motor (25) realized as an external-rotor motor having a planetary gear mechanism (26), which comprises the following steps:
Provision of a stator (1) of the electric motor (25) with coils for generating magnetic fields, wherein the coils (7) have connections (23) for a supply voltage;
Provision of a rotor (13) of the electric motor (25) with permanent magnets, wherein the permanent magnets (16) are situated radially opposite the coils (7) with reference to a an axis of rotation of the rotor (13);
The supply voltage is switched so that the magnetic field generated by means of the current flowing through the coils (7) exercises a force of attraction on the permanent magnets (16) of the rotor (13) and thus exercises torque on the rotor (13).

36. Method according to numeral 35,

wherein an electronic commutator is used for switching the supply voltage.

37. Method according to numeral 36,

wherein the supply voltage is triggered by a Hall sensor.

38. Method according to numeral 36,

wherein the supply voltage is triggered by evaluating induction currents in the coils (7).

1. Electric motor (25) for a motor vehicle that comprises the following:
a stator (1) with predefined areas (4) for a connection to a vehicle frame;
a rotor (13);
predefined areas for receiving a driving means;
a planetary gear mechanism (26);
the electric motor (25) is realized a an external-rotor motor, wherein the rotor (13) is mounted rotatably relative to the stator (1),
wherein the drive shaft (17) is mounted in a hollow shaft (10),
wherein a ring gear (29) of the planetary gear mechanism (26) is connected to the rotor (13),
wherein a sun wheel (27) of the planetary gear mechanism (26) is connected to the hollow shaft (10), and
wherein a planetary carrier (31) of the planetary gear mechanism (26) is connected to the drive shaft (17).

2. Electric motor (25) according to claim 1, wherein cranks (19) with pedals (20) are affixed to the ends of the drive shaft (17).

3. Electric motor (25) according to one of claims 1 to 2, wherein the drive shaft (17) has a free-wheeling device (33) in a transitional area to the rotor (13).

4. Electric motor (25) according to claims 1 to 3, wherein the electric motor (25) is realized as a electronically commuted d.c. external-rotor motor.

5. Electric motor (25) according to one of claims 1 to 4, wherein the electric motor (25) is realized brushless and the rotor (13) has a number of permanent magnets (16).

6. Electric motor (25) according to one of claims 1 to 5, wherein the areas for receiving a driving means are realized as a sprocket wheel (22).

7. Electric motor (25) according to one of claims 1 to 6, wherein the areas for receiving a driving means are realized as a toothed belt wheel.

8. Electric motor (25) according to one of claims 1 to 7, wherein the areas for receiving a driving means are realized as a cardan pinion.

9. Electric motor (25) according to one of claims 1 to 8, wherein the areas for receiving the driving means are fixedly connected to the drive shaft (17) or to areas of the planetary gear mechanism (26).

10. Motor vehicle having an electric motor (25) according to one of claims 1 to 9, wherein the stator (1) of the electric motor (25) is connected to frame tubes (3) of the motor vehicle and a sprocket wheel (22) of the electric motor (25) is connected by a driving means to a wheel of the motor vehicle.

11. Motor vehicle according to claim 11, wherein the rotor (13) has a diameter D of 250 mm ≦D≦350 mm and wherein the rotor (13) has a height of 30 mm ≦h≦60 mm.

12. Motor vehicle according to one of claim 10 or 11, wherein the driving means is realized as a chain.

13. Motor vehicle according to one of claims 10 to 12, wherein the driving means is realized as a toothed belt.

14. Motor vehicle according to one of claims 10 to 13, wherein the electric motor (25) is fastened by screws or welded to frame tubes (3) of the motor vehicle.

15. Motor vehicle according to one of claims 10 to 14, wherein the motor vehicle has a wheel suspension with a rocker arm that is mounted on the motor vehicle rotatably around an axis of rotation, wherein the axis of rotation of the rocker arm corresponds substantially to the axis of rotation of the rotor (13).
